(19) United States
(12) Patent Application Publication
(10) Pub. No.: US 2011/0209592 A1
(43) Pub. Date: Sep. 1, 2011

(54) SLIDING TABLE SAW HAVING MAGNETIC GUIDE RAIL SYSTEM

(75) Inventor: Brian H. Chung, Arlington Heights, IL (US)

(73) Assignees: ROBERT BOSCH TOOL CORPORATION, Broadview, IL (US); ROBERT BOSCH GMBH, Stuttgart (DE)

(21) Appl. No.: 12/715,183

(22) Filed: Mar. 1, 2010

(51) Int. Cl. B23D 47/02; B23D 45/06

(52) U.S. Cl. 83/446; 83/477.2

(57) ABSTRACT

A saw assembly includes a base defining an internal space, and having a sidewall defining an opening, a table top structure supported by said base and defining a blade slot, a support arrangement including (i) a first rail assembly attached to said base and having a first rail magnet, (ii) a carriage located within said internal space and having a first carriage magnet that is positioned to magnetically interact with said first rail magnet, a saw mechanism supported by said carriage and including a motor and a saw blade rotatably coupled to said motor, said saw blade extending through said blade slot, and an actuator having (i) a first end portion attached to said carriage, (ii) a second end portion spaced apart from said internal space, and (iii) an intermediate portion extending through said opening, wherein movement of said second end portion of said actuator causes movement of said carriage in relation to said first rail assembly.

### FIELD

The present invention relates generally to power tools and more particularly to a pull-push table saw.

### BACKGROUND

A table saw can be used for cutting a workpiece, e.g., a board. The table saw includes a saw unit that includes a circular blade that is coupled to a saw motor. Two types of table saws are known. In the first known type, the saw unit is stationary and an operator of the table saw slides the workpiece toward the circular blade to cut the workpiece, followed by pulling the workpiece away from the circular blade after the workpiece is cut. In the second known type (a pull-push table saw), the workpiece is stationary and the operator pulls the saw unit toward the workpiece to cut the workpiece, followed by pushing the saw unit away from the workpiece once the workpiece is cut. A typical construction in the latter type of table saw includes an undercarriage that is configured to slide on a rail system for the purpose of pulling, and then pushing the saw unit. The undercarriage is typically spring-loaded and is biased to return to a home position away from the workpiece. To reduce friction between the undercarriage and the rail system, provisions have been provided in the known pull-push table saws. Among these provisions are rollers and bearing surfaces that interface the undercarriage with the rail system. However, the roller-bearing provision may be susceptible to malfunctioning, e.g., sticking, when debris, produced during a cutting operation, is introduced between the rollers and the bearing surface.

Therefore, there is a need to provide an improved interface between the undercarriage of a table saw and the rail system. There is further a need to provide a low friction or essentially frictionless interface between the undercarriage of a table saw and an associated rail system. There is yet an additional need to provide an interface between the undercarriage of a table saw and the associated rail system that is less susceptible to malfunctioning due to debris produced during a cutting operation.

### SUMMARY

According to one embodiment of the present disclosure, a saw assembly is disclosed. The saw assembly includes a base, a support arrangement which includes (i) a first rail assembly attached to said base and having a first rail magnet, (ii) a carriage having a first carriage magnet that is positioned to magnetically interact with said first rail magnet, and a saw mechanism supported by said carriage.

According to another embodiment of the present disclosure a saw assembly is disclosed. The saw assembly includes a base defining an internal space, and having a sidewall defining an opening, a table top structure supported by said base and defining a blade slot, a support arrangement including (i) a first rail assembly attached to said base and having a first rail magnet, (ii) a carriage located within said internal space and having a first carriage magnet that is positioned to magnetically interact with said first rail magnet, a saw mechanism supported by said carriage and including a motor and a saw blade rotatably coupled to said motor, said saw blade extending through said blade slot, and an actuator having (i) a first end portion attached to said carriage, (ii) a second end portion spaced apart from said internal space, and (iii) an intermediate portion extending through said opening, wherein movement of said second end portion of said actuator causes movement of said carriage in relation to said first rail assembly.

### BRIEF DESCRIPTION OF THE DRAWINGS

The above described features and advantages, as well as others, will become more readily apparent to those of ordinary skill in the art by reference to the following detailed description and accompanying drawings.

FIG. 1 depicts a perspective schematic view of a push-pull table saw of the present disclosure with its table top removed for clarity of description;

FIG. 2 depicts a perspective schematic view of a table top of the push-pull table saw of FIG. 1 with a circular saw blade passing through a slot defined in the table top;

FIG. 3 depicts a fragmentary top schematic view of the push-pull table saw of FIG. 1;

FIG. 4 depicts a cross sectional view of a magnetic support interface of the push-pull table saw of FIG. 3; and

FIG. 5 depicts an enlarged fragmentary view of the portion of FIG. 4 that is encircled and labeled as “FIG. 5.”

### DETAILED DESCRIPTION

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

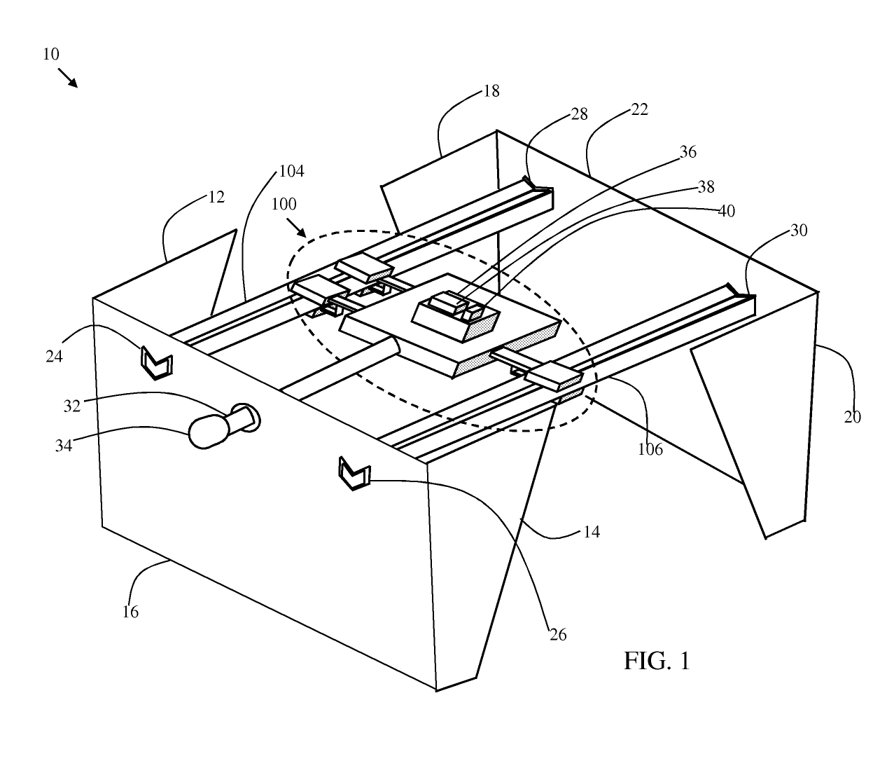

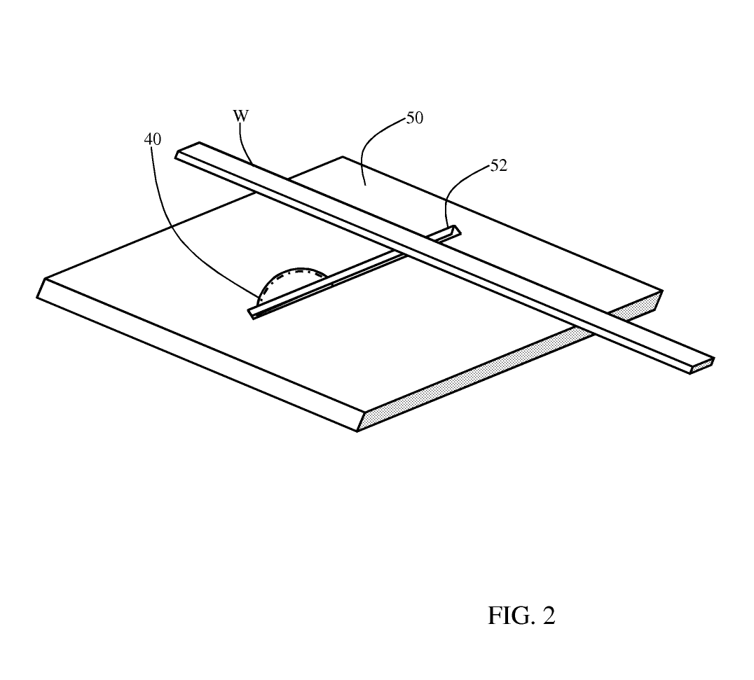

FIG. 1 depicts a sliding table saw 10 of the push-pull type. The sliding table saw 10 includes side support walls 12, 14, 18, and 20, a front support wall 16, a rear support wall 22, rails 104 and 106, rail brackets 24, 26, 28, and 30, and a slide rod 32. The sliding table saw 10 also includes a magnetic slide system 100, which includes a saw mechanism 36 having a motor 38 and a saw blade 40. The sliding table saw 10 also includes a table top 50, shown in FIG. 2, configured to support a workpiece W. The table top 50 centrally includes a slot 52 for the saw blade 40 to pass through the slot 52 to cut or shape the workpiece W that is supported on the table top 50. The slide rod 32 is connected to the magnetic slide system 100. A handle 34 is connected to one end of the slide rod 32.

The combination of side, front and rear support walls 12, 14, 16, 18, 20, and 22 provide a structural frame for the sliding table saw 10, and particularly for the table top 50. The table top 50 fastens to a top surface of the side, front and rear support walls 12, 14, 16, 18, 20, and 22. Rails 104 and 106 are received by rail brackets 24, 26, 28, and 30 to support the rails 104 and 106. The rail brackets (24, 26, 28, and 30) support the rails 102 and 104, and the rails 104 and 106 support the magnetic slide system 100. Also, while rail brackets 24, 26, 28, and 30 are depicted in FIG. 1, it should be appreciated that other interfaces for coupling the rails 104 and 106 to the front and back support walls 16 and 22 may be implemented.

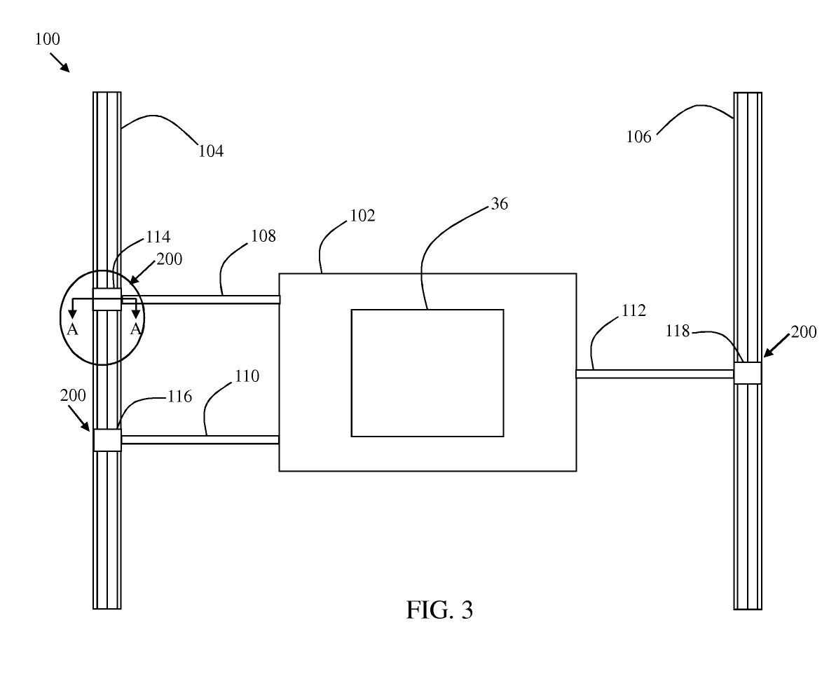

FIG. 3 depicts the magnetic slide system 100 in more detail. The magnetic slide system 100 includes the undercarriage 102, top connecting members 108, 110, and 112, top magnetic support members 114, 116, and 118, and the saw mechanism 36. The undercarriage 102 is connected to the top connecting members 108, 110, and 112. The top connecting members 108, 110, and 112 are connected to the top magnetic support members 114, 116, and 118, respectively. The connecting members 108, 110, and 112 are configured to provide minimal horizontal deflection under the weight of the undercarriage 102 and the saw mechanism 36. The saw mechanism 36 is mounted to the undercarriage 102 by fasteners (not shown).

While two rails 104 and 106 are depicted in FIG. 3, it should be appreciated that a variety of other configurations are also possible. For example, a single rail below the undercarriage 102 may provide appropriate support and stability for the undercarriage 102 and the saw mechanism 36.

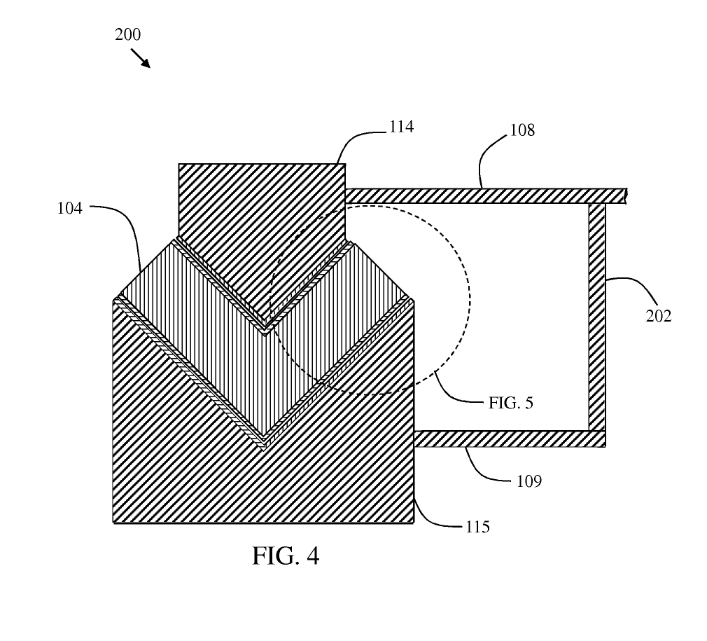

The magnetic slide system 100 and the rails 104 and 106, define three (3) magnetic support interfaces 200, as shown in FIG. 3. A cross sectional view of a magnetic support interface 200 about the line identified as AA in FIG. 3 is depicted in FIG. 4. The magnetic support interface 200 is defined by the top connecting member 108, a bottom connecting member 109, the top magnetic support member 114, a bottom magnetic support member 115, and a brace 202. The top connecting member 108 is connected to the top magnetic support member 114 by fasteners, not shown, or by spot welding. Alternatively, the top connecting member 108 and the top magnetic support member 114 may be integrally formed as one piece. The bottom connecting member 109 is connected to the bottom magnetic support member 115 by fasteners, not shown, or by spot welding. Alternatively, the bottom connecting member 109 and the bottom magnetic support member 115 may be integrally formed as one piece. The top connecting member 108 is connected to the bottom connecting member 109 by the brace 202. The connection between the top and bottom connecting members 108 and 109 and the brace 202 is formed by fasteners, not shown, or spot welding. Alternatively, the top connecting member 108, the bottom connecting member 109, and the brace 202 may be integrally formed as one piece. While the brace 202 is depicted as the connecting member between the top and bottom connecting members 108 and 109, it should be appreciated that the bottom connecting member may alternatively extend and connect to the undercarriage 102 directly.

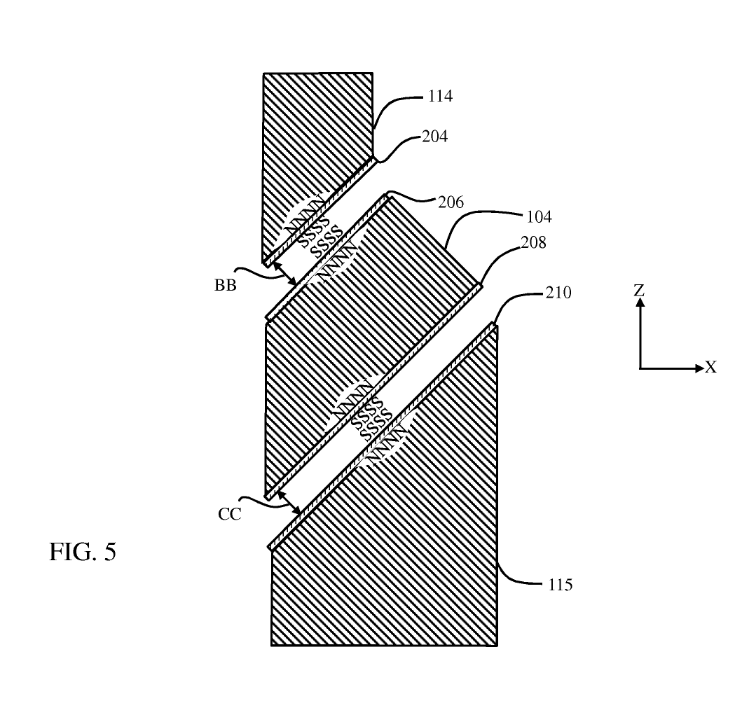

FIG. 5 depicts further details of the magnetic support interface 200. The magnetic support interface 200 is further defined by a first magnetic strip 204, a second magnetic strip 206, a third magnetic strip 208, and a fourth magnetic strip 210. The first magnetic strip 204 is connected to a bottom surface of the top magnetic support member 114. The second magnetic strip 206 is connected to a top surface of the rail 104. The third magnetic strip 208 is connected to a bottom surface of the rail 104. The fourth magnetic strip 210 is connected to a top surface of the bottom support member 115. The first and the second magnetic strips 204 and 206 are positioned to magnetically interact with each other. Similarly, the third and fourth magnetic strips 208 and 210 are positioned to magnetically interact with each other. Each of the first, second, third, and fourth magnetic strips 204, 206, 208, and 210 has a first pole spanning one longitudinal face of the strip and a second pole spanning the second longitudinal face of the strip. The first and second magnetic strips 204 and 206 have the same pole facing toward each other. In particular, the longitudinal faces of the first and second magnetic strip 204 and 206 that face each other have an “S” pole. The longitudinal faces of the first and second magnetic strips 204 and 206 that face the top magnetic support member 114 and the rail 104, respectively, have the opposite pole, i.e., the “N” pole. Similarly, the third and fourth magnetic strips 208 and 210 have the same pole pointing toward each other. Specifically, the longitudinal faces of the third and fourth magnetic strips 208 and 210 that face each other have the “S” pole. The longitudinal faces of the third and fourth magnetic strip 208 and 210 that face the rail and the bottom magnetic support member 114, respectively, have the opposite pole, i.e., the “N” pole. The orientation of the poles of the first, second, third, and fourth magnetic strips 204, 206, 208, and 210 are depicted in FIG. 5 in the cutouts shown in the top and bottom magnetic support members 114 and 115.

Since the longitudinal faces of the first and second magnetic strips 204 and 206 that face each other have the same pole, these strips generate a magnetic field that tends to push the first and second magnetic strips 204 and 206 apart from each other. Therefore, the interface between the first and second magnetic strips 204 and 206, and the weight of the undercarriage 102 and other components coupled thereto, generates a net repulsion force which results in an air gap, shown in FIG. 5 as BB. Therefore, the undercarriage 102 and other components coupled thereto levitate above the rails 104 and 106. While calculating the repulsive force between the first and second magnetic strips 204 and 206 is a complex mathematical operation that depends on the shape, magnetization, orientation and separation of the first and second magnetic strip 204 and 206, it is known in the art that the force between two magnetic poles is inversely proportional to the distance between the two poles. Therefore, the repulsion force generated between the first and the second magnetic strips 204 and 206 is inversely proportional to the distance between these strips, i.e., the air gap BB.

Similarly, since the longitudinal faces of the third and fourth magnetic strips 208 and 210 that face each other have the same pole, these strips oppose each other and thereby generate a magnetic field that tends to push the third and fourth magnetic strips 208 and 210 apart from each other to generate an air gap CC. The repulsion force between the third and fourth magnetic strips 208 and 210 is in an opposite direction than the repulsion force of the first and second magnetic strips 204 and 206. Therefore, the weight of the undercarriage and the components coupled thereto, and the repulsion force between the third and fourth magnetic strips 208 and 210 cooperate to oppose the repulsion force generate by the interface between the first and second magnetic strips 204 and 206. Also, upward forces generated during a cutting operations of the saw mechanism 36 on the workpiece W, cooperate with the repulsion force generated by the interface between the first and second magnetic strips 204 and 206 to oppose the repulsion force generated by the magnetic interaction between the third and fourth magnetic strips 208 and 210. These repulsion forces, the weight of the undercarriage and components coupled thereto as well as the upward forces generated during the cutting operation cause the top and bottom magnetic support members 114 and 115 to levitate above the rail 104 to provide a vertically stable sliding system.

Although the above described forces are in a vertical direction, because of the geometric configuration of the top and bottom magnetic support members 114 and 115 and the rail 104, the repulsion force generated between the first and second magnetic strips 204 and 206, and between the third and fourth magnetic strips 208 and 210 have components that lie in both a horizontal direction, X axis shown in FIG. 5, and in the vertical direction, Z axis shown in FIG. 5. While, the vertical components of the forces generate vertical stability for the magnetic support interface, the horizontal components of the forces generate horizontal stability. In particular, the shape of the rails 104 and 106 and the top and bottom magnetic support members 114 and 115, generate a tight horizontal structural interface that minimizes undesirable side to side movement of the undercarriage 102 and other components coupled thereto.

### Operation of the Sliding Table Saw

An operator of the sliding table saw 10 places the workpiece W on the table top 50 which is supported by the side, front and rear support walls 12, 14, 16, 18, 20, and 22. The operator raises the saw blade 40 through the slot 52 of the table top 50 in a manner known in the art, e.g., by using a cam and rollers, to an appropriate height for cutting the workpiece W. Similarly, the operator tilts the saw blade 40 to an appropriate bevel angle, in a manner known in the art. The operator grips the handle 34 and slides the undercarriage 102 of the magnetic slide system 100 toward and away from the workpiece W. The magnetic interactions between the magnetic strips 204, 206, 208, and 210 result in a smooth sliding action of the undercarriage 102 and the saw mechanism 36 mounted thereto.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

1. A saw assembly, comprising:
a base;
a support arrangement including (i) a first rail assembly attached to said base and having a first rail magnet, (ii) a carriage having a first carriage magnet that is positioned to magnetically interact with said first rail magnet; and
a saw mechanism supported by said carriage.

2. The saw assembly of claim 1, wherein:
said first rail assembly includes a first rail to which said first rail magnet is secured,
said first rail is attached to said base,
said carriage includes (i) a saw support on which said saw mechanism is supported, and (ii) a first interface attached to said saw support, and
said first carriage magnet is secured to said first interface.

3. The saw assembly of claim 2, wherein:
said first rail defines a rail cavity,
said first rail magnet is located within said rail cavity, and
said first carriage magnet is located within said rail cavity.

4. The saw assembly of claim 3, wherein:
said first rail, when viewed in a cross sectional view, defines a V-shaped substrate, and
said V-shaped substrate defines said rail cavity.

5. The saw assembly of claim 4, wherein:
said first rail magnet is V-shaped, and
said first carriage magnet is V-shaped.

6. The saw assembly of claim 1, further comprising an actuator, wherein:
said base (i) defines an internal space, and (ii) has a side wall defining an opening,
said carriage is located within said internal space and movable in relation to said first rail assembly,
said actuator is attached to said carriage and extends through said opening, and
movement of said actuator causes movement of said carriage.

7. The saw assembly of claim 1, further comprising a table top structure supported by said base, wherein:
said table top structure defines a slot,
said saw mechanism includes a motor and a saw blade rotatably coupled to said motor, and
said saw blade extends through said slot.

8. The saw assembly of claim 2, wherein:
said support arrangement further includes a second rail assembly attached to said base and having a second rail magnet,
said second rail assembly is spaced apart from said first rail assembly, and
said carriage further has a second carriage magnet that is positioned to magnetically interact with said second rail magnet.

9. The saw assembly of claim 8, wherein said carriage is interposed between said first rail assembly and said second rail assembly.

10. The saw assembly of claim 8, wherein:
said second rail assembly includes a second rail to which said second rail magnet is secured,
said second rail is attached to said base,
said carriage further includes a second interface attached to said saw support, and
said second carriage magnet is secured to said second interface.

11. The saw assembly of claim 2, wherein:
said first rail assembly further includes a second rail magnet,
said carriage further includes a second carriage magnet,
said first interface includes a first magnet support structure and a second magnet support structure,
said first carriage magnet is secured to said first magnet support structure,
said second carriage magnet is secured to said second magnet support structure,
said first rail is interposed between said first magnet support structure and said second magnet support structure, and
said second carriage magnet is positioned to magnetically interact with said second rail magnet.

12. The saw assembly of claim 10, wherein:
said first rail defines a first rail cavity,
said second rail defines a second rail cavity,
said first rail magnet is located within said first rail cavity, and
said second rail magnet is located within said second rail cavity, and
said first carriage magnet is located within said first rail cavity.
said second carriage magnet is located within said second rail cavity.

13. The saw assembly of claim 12, wherein:
said first rail magnet is V-shaped,
said second rail magnet is V-shaped,
said first carriage magnet is V-shaped, and
said second carriage magnet is V-shaped.

14. The saw assembly of claim 2, wherein:
said first interface includes (i) an elongate member having a first end portion and a second end portion, and (ii) a magnet support structure,
said first end portion of said elongate member is connected to saw support,
said second end portion of said elongate member is connected to said magnet support structure, and
said first carriage magnet is secured to said magnet support structure.

15. A saw assembly, comprising:
a base defining an internal space, and having a sidewall defining an opening;
a table top structure supported by said base and defining a blade slot;
a support arrangement including (i) a first rail assembly attached to said base and having a first rail magnet, (ii) a carriage located within said internal space and having a first carriage magnet that is positioned to magnetically interact with said first rail magnet;
a saw mechanism supported by said carriage and including a motor and a saw blade rotatably coupled to said motor, said saw blade extending through said blade slot; and
an actuator having (i) a first end portion attached to said carriage, (ii) a second end portion spaced apart from said internal space, and (iii) an intermediate portion extending through said opening, wherein movement of said second end portion of said actuator causes movement of said carriage in relation to said first rail assembly.

16. The saw assembly of claim 15, wherein:
said first rail assembly includes a first rail to which said first rail magnet is secured,
said first rail is attached to said base,
said carriage includes (i) a saw support on which said saw mechanism is supported, and (ii) an interface attached to said saw support, and
said first carriage magnet is secured to said interface.

17. The saw assembly of claim 16, wherein:
said first rail defines a rail cavity,
said first rail magnet is located within said rail cavity, and
said first carriage magnet is located within said rail cavity.

18. The saw assembly of claim 17, wherein:
said first rail, when viewed in a cross sectional view, defines a V-shaped substrate,
said V-shaped substrate defines said rail cavity,
said first rail magnet is V-shaped, and
said first carriage magnet is V-shaped.

19. The saw assembly of claim 15, wherein:
said support arrangement further includes a second rail assembly attached to said base,
said second rail assembly has a second rail magnet,
said carriage further has a second carriage magnet that is positioned to magnetically interact with said second rail magnet,
said second rail assembly is spaced apart from said first rail assembly, and
said carriage is interposed between said first rail assembly and said second rail assembly.

20. The saw assembly of claim 16, wherein:
said interface includes (i) an elongate member having a first end portion and a second end portion, and (ii) a magnet support structure,
said first end portion of said elongate member is connected to saw support,
said second end portion of said elongate member is connected to said magnet support structure, and
said first carriage magnet is secured to said magnet support structure.
